(19) United States
(12) Patent Application Publication
(10) Pub. No.: US 2003/0015109 A1
(43) Pub. Date: Jan. 23, 2003

(54) Method for adjustment of a belt tension in a rotary press machine

(76) Inventors: Erhard Herbert Glockner, Eibelstadt (DE); Dieter Koch, Oberrohdorf (CH)

Correspondence Address: Douglas R Hanscom, Jones Tullar & Cooper, PO Box 2266 Eads Station, Arlington, VA, 22202, US

(21) Appl. No.: 10/181,945

(22) PCT Filed: Jan. 5, 2001
(86) PCT No.: PCT/DE01/00012

(30) Foreign Application Priority Data
Feb. 4, 2000 (DE) 100 04 933.8
Jun. 2, 2000 (DE) 100 27 471.4

(51) Int. Cl. B41F 13/54

(52) U.S. Cl. 101/228

(57) ABSTRACT

The invention relates to a method for adjustment of a belt tension in a rotary press machine, whereby the belt (B) runs through at least one printing group (06, 07, 08, 09) and a change in the stretch of the belt during the production run is determined by means of a change in the difference between a first speed (u 09) and a second speed (u 11). The change in the stretch is compensated by a change n the tension of the belt before the first printing group (06).

The invention relates to a method for controlling a web tension in a rotary printing press according to the preamble to claim 1.

EP 09 51 993 A1 has disclosed a register-preserving actuation for a rotary printing press, in which a longitudinal stretch of the printing web is ascertained from web tension values and operational data of the drive units and is compensated by adjusting the circumferential register on the cylinders or the register rolls. A change in the lateral stretch, which is ascertained by means of a sensor for detecting web width, is restored to its original value by changing the reference value of the draw roller, which is adjusted to a constant web tension.

U.S. Pat. No. 3,025,791 A has disclosed a method for controlling the drive units of a printing press with the aim of achieving a constant stretch. The measurement of the stretch in this instance takes place in close proximity to the first printing unit, through comparison of the angular position of the printing unit and then the position of a mark on the print stock. A change in the relative position between the angular position of the printing unit and the position of the mark results in a tension change for the print stock web in the infeed unit.

DE 198 34 725 A1 has disclosed a number of methods for controlling web tension. In this instance, among other things, the web tension is measured and with this measurement, the tension is restored to a reference value or a reference range for the tension or is restored to a mathematically calculated speed for a lagging or advancing of one drive unit in relation to a second drive unit. The web tension in this instance is kept constant by means of a simple web tension control, a web tension control that has been expanded to include a presettable reference value for the speed, or a lag control—with or without DROOP behavior.

DE 29 51 246 C2 has disclosed a device of a printing press, which makes it possible to adjust the speeds of a paper web at different points in relation to one another, in the example, the drive unit of the printing unit on the one hand and that of the draw roller on the other. In this case, by means of motor shaft encoders, impulses that correspond to the speed can be detected and are supplied to a motor control circuit.

The object of the invention is to provide a method for controlling a web tension in a rotary printing press.

The object is attained according to the invention by the characteristics of claim 1.

The advantages that can be achieved with the invention are comprised particularly in the fact that by measuring and comparing the circumference speeds of the last printing unit and the subsequent draw roller, a number of tasks can be inexpensively fulfilled, without incurring steep additional expenses related to measurement techniques. The stretch of the web is kept constant despite fluctuating web properties and operating parameters.

In particular when starting up a printing unit, a printing tower, or an entire multi-web rotary printing press, at least sometimes there is a printing startup without water and/or ink, i.e. with a dry web. Before a printing startup of the cylinders occurs, a largely uniform web tension prevails before and after the printing units since the web is not placed under tension by the printing units. For the web travel, though, it is advantageous if after printing startup, but in the operation without water and/or ink, the web tension is also approximately the same before the first printing unit and after the last printing unit. This is the case if the circumference speeds of the last printing unit and the subsequent draw roller are approximately the same, which can be advantageously assured by means of the invention.

When the water and ink are switched on, the tension/stretch behavior of the web changes as it passes through the printing zones and results in a tension reduction after the last printing unit since the subsequent draw roller is for the time being still traveling with the same circumference speed as the last printing unit. So that a trouble-free entry of the webs into the hopper is assured in multi-web operation, in order to achieve the necessary graduation in the web tension, after the water and/or ink are switched on, but before the print run speed has been reached, the appropriate web tension level of the webs are matched to each other, if possible only by means of adjustments to the infeed unit.

The paper web stretches under the influence of the wetting agent and/or the ink in both the longitudinal and lateral direction in relation to the transport direction. Particularly in multicolor printing where there are free path lengths between adjacent printing zones, this is reflected in a spreading of the print image or of several adjacent print images as they continue on their way through the printing zones. Provided that this so-called fan-out effect remains virtually constant over time in each printing zone, the effect can be at least partially compensated, for example by printing formes, which are disposed so that they diverge in a corresponding manner. The stretch behavior of the paper web, however, is subjected to numerous influences, such as the tension/stretch characteristics of the respective paper and consequently the prevailing tension, the current moisture, the moisture sensitivity, the penetration behavior, and even the position of the roll as it is produced in the reel, which is reflected, for example, in a variable winding hardness.

The stretch, both the longitudinal and lateral stretch, is therefore not steady due to the inconstant paper properties of the unrolling paper web itself and due to changing and partially fluctuating operating parameters in the printing press. For example, the paper web on the roll has been subjected to an uneven winding in its manufacture, a location-dependent fluctuation in the modulus of elasticity, or other irregularities. As a rule, these properties vary greatly from paper type to paper type. Even with the same paper type, the properties can vary considerably from roll to roll. On the other hand, a fluctuating web tension, changing printing speeds, fluctuations in the wetting, or a roll change influence the stretch of the paper web so that the longitudinal stretch and lateral stretch in relation to the transport direction are not steady over time.

When there are fluctuations in the properties of the web and changing operating parameters, e.g. in the wetting, the mathematical correlation of a tension/stretch characteristic curve is abandoned and changes to a temporarily unknown characteristic curve. Furthermore, if only a constant tension is set, this results in a deviation in the stretch and in the effective unwinding length of the print image on the web B, which results in errors in the image length on the web B and also in the circumference and/or side register. The current method eliminates this disadvantage; the stretch is kept constant even with the above-mentioned inconstant web properties and/or operating conditions.

The method according to the invention advantageously assures a more reliable starting procedure, establishes a normal setting, and compensates additional fluctuations in the stretch in the longitudinal and/or lateral stretch.

In a particular embodiment, during the starting phase (without ink and water), the draw roller disposed after the last printing unit is driven in a speed-controlled fashion in relation to a printing unit; during print running, this draw roller is moment-controlled in relation to a presettable reference value. The speeds of the draw roller and the printing unit that continue to be measured during a print run are used to control the infeed unit. After print run speed has been reached, the existing difference between the circumference speeds of the draw roller, which as a rule advances during print running, and the circumference speed of the printing unit constitutes a reference value. A change in this difference indicates a change in the stretch, not only a longitudinal stretch but also a lateral stretch of the print stock web, and consequently a change in the image length on the web B and/or in the lateral and longitudinal register. The moment control produces a temporary speed change of the drive unit of the draw roller. The relative speed change in turn then controls the infeed unit, which finally permits the moment-controlled draw roller to return to its “normal operation”. A change in the stretch or tension is measured after the last printing unit, a controlling action, though, is executed at the infeed unit, which defines the overall tension level of the paper web. Advantageously, there is no direct feedback to the draw roller situated after the printing unit; instead, there is a change in the overall tension level at the infeed unit. A particularly advantageous feature is the fact that the web tension after the draw roller is kept largely constant, which can be achieved through combination of the moment-controlled draw roller with the control of the infeed unit as to the difference between the circumference speeds, without additional expenses related to measurement and control techniques.

It is advantageous if the stretch change is ascertained at the end of the printing tower or after the last printing unit, since this offers a good insight for the additional processing steps as to the overall change and makes it possible to execute a countermeasure to achieve a constant tension of the web for the subsequent paths of the web. In this sense, it is also advantageous that the control does not take place in the vicinity of the measurement zone, but at the beginning of the web, which establishes a base level for the course of the tension, without causing significant changes in the web tension in the superstructure, in particular before the hopper infeed roller.

A virtually constant portion in the longitudinal stretch, e.g. for the purpose of preadjusting the printing press for the expected or measured operating conditions and paper conditions, can be compensated, e.g. by means of register adjustment in the cylinders, by means of register rolls, or by means of other devices.

It is also advantageous that both the requirement mentioned at the beginning for a speed-controlled startup, and, after the switching on of the water and ink, the second requirement for a control of changes in the fan-out effect or the lateral register and in the image length when the web tension after the draw roller is kept largely constant, are fulfilled without requiring, for example, additional systems for image detection or the like in order to preserve the lateral register.

An exemplary embodiment of the invention is shown in the drawings and will be explained in detail below.

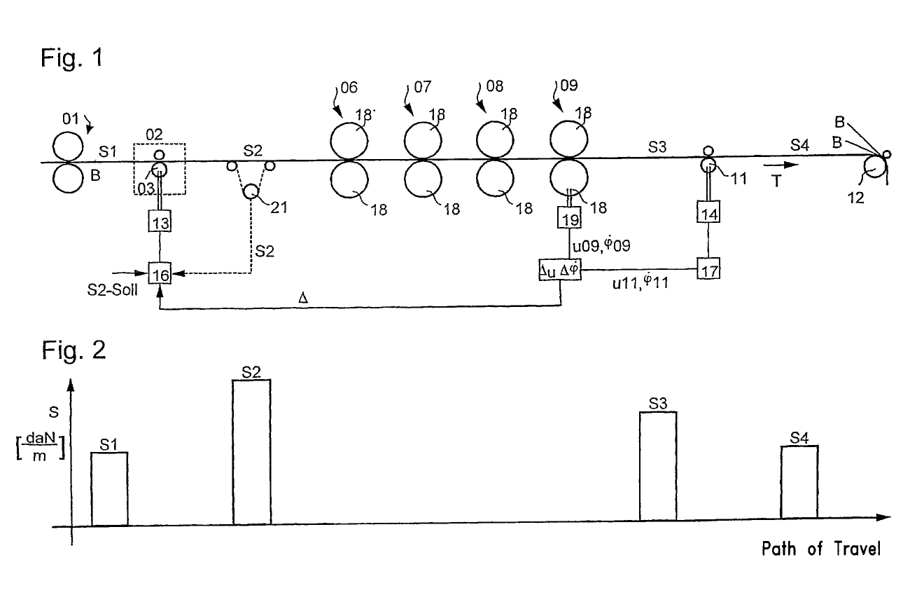

FIG. 1 shows a schematic depiction for the guidance of a web from the infeed unit, via four printing units, and a second draw roller, to a hopper infeed roller;

FIG. 2 schematically depicts the web tension level during a print run.

FIG. 1 schematically depicts the passage of a web B, for example a print stock web B or a paper web B, on its path through a printing press, in particular a rotary printing press. The web B travels in the transport direction T from the roll changer 01, through an infeed unit 02 with a draw roller 03, through four printing units 06 to 09, and to a second draw roller 11. The second draw roller 11 is followed, for example, by turning bars, cutting blades, additional draw rollers or guide rollers, and finally a hopper infeed roller 12. The essential draw rollers 03 and 11 are each equipped with their own drive units 13 and 14 and a drive control unit 16; 17. In a preferred embodiment, the

tensions S1; S2; S3; and S4 of the web B are measured before the infeed unit 02, between the infeed unit 02 and the first printing unit 06, between the last printing unit 09 and the draw roller 11, and on the free path between the draw roller 11 and the hopper infeed roller 12. This can be executed, for example, by means of measuring rollers or by means of the power consumption of the drive motors of the traction units.

The starting point for the adjustment of web tensions, particularly when, in multi-web operation, a number of webs B are combined at the hopper entry to form a multi-ply composite on the hopper infeed roller 12, is the absolute and relative tensions S4 of the individual webs B in relation to one another on the hopper infeed roller 12 (several webs indicated in FIG. 1). Therefore, the adjustment of the tensions in the web B takes place based on the desired tension level in the hopper infeed roller 12. Preferably, the web tension level is established by adjusting the infeed unit 02. A change in the web tension also advantageously takes place by a change in the tension S2 at the infeed unit 02. In order to place the web B under tension, the first draw roller 03 is therefore operated so that it lags behind the machine speed. During print running, i.e. at production speed and with the addition of water and ink, the second draw roller 11 is as a rule driven so that it advances ahead of the machine speed. The machine speed is measured, for example, at a cylinder 18, for example a transfer cylinder 18 of the last printing unit 09. The circumference speed u09 can be ascertained, for example, by means of the rotation angle position or phase position φ 09 or by means of the change over time in the rotation angle position or phase position φ′ 09 or by means of the position of a drive unit 19 or by means of a mark and a detector on the transfer cylinder 18 or another cylinder such as the forme cylinder or counter-pressure cylinder.

The draw roller 03 and the hopper infeed roller 12 and if need be, drive units disposed between the second draw roller 11 and the hopper infeed roller 12 can be controlled in terms of their speed and/or rotation position for operation at production speed. In particular, the draw roller 03 can be regulated in such a way that the tension S2 between the infeed unit 02 and the first printing unit 06 is continuously restored to a reference value.

At printing startup, the draw roller 11 is operated without water and/or ink, i.e. with a dry web B, in a controlled manner that uses its circumference speed u11 as a control variable and during print running, is operated with water and ink in a moment-controlled manner.

In terms of the travel of a dry web B, it is advantageous if the same tensions S2 and S3 prevail before the first printing unit 06 and after the last printing unit 09. Since in the dry state, the web B is not exposed to any significant stretch due to moisture influences, in this phase, the circumference speeds u09 of the last printing unit 09 and the circumference speeds u11 of the draw roller 11 should consequently be approximately the same. An advancing of the draw roller 11 would lead to unnecessarily high tensions S3 of the web B or even to web breakage. The drive unit 14 of the draw roller 11 is correspondingly actuated by means of the drive control unit 17, in that the two circumference speeds u09 of the printing unit 09 and u11 of the draw roller 11 are compared and a possibly occurring difference Δu is restored to the circumference speed u09 predetermined by the machine speed. This is achieved, for example, by increasing or decreasing the circumference speeds u11 of the draw roller 11 so that Δu is approximately equal to 0 or so that Δu lies within presettable tolerance limits.

When the water and ink are switched on, the tension and stretch behavior of the web B changes as it passes through the individual printing zones of the printing units 06 to 09 and results in a decrease in the tension S3 after the last printing unit 09, since for the time being, the draw roller 11 is still traveling with the same circumference speed u11 as the last printing unit 09. After this and during print running, the draw roller 11 is then operated in a moment-controlled manner. So that a trouble-free entry of the webs B into the hopper is assured in multi-web operation, preferably, in order to achieve the necessary, known graduation in the web tensions S4 of several webs B in relation to one another, after the water and/or ink are switched on, but before the print run speed has been reached, the appropriate web tension level of the web B is matched, if possible only by means of adjustments to the infeed unit 02. This can take place, for example, by means of the draw roller 03 or a dancing roller, not shown, which is disposed in the infeed unit 02.

A normal setting of the tensions during print running, as schematically depicted in FIG. 2, is produced, for example, by means of the web tension-controlled, speed-controlled, or position-controlled draw roller 03, which results in a control of the hopper infeed roller 12 and/or dancing rollers, not shown. This as a rule tension-controlled state of the web B, by means of a lagging of the draw roller 03, and an advancing of the draw roller 11 in relation to the machine speed, already takes into account a constant portion (expected or measured) of a longitudinal change in the web B, which takes place after and during the passage through the printing units 06 to 09 due to moisture influences. Even symmetrical and constant fan-out effects in the lateral register can already be taken into account here.

In order then during print running to be able to counteract changes or fluctuations in the lateral register or in the image length, of the kind that can occur, for example, during roll changing, during adjustments to the fountain solution, during speed changes, etc., the circumference speeds u09 and u11 are again compared and an existing difference Δu is stored as a reference value Δu-ref in the storage unit. This should subsequently be equivalent to the ascertainment of the phase position φ 09 or the change over time in the phase position φ′ 09 and a rotation angle position or phase position φ 11 or the change over time in the phase position φ′ 11, where a change is measured as a difference Δφ′

and is recorded as Δφ′-ref in the storage unit. Then during print running in continuous production, if a deviation in the difference Δu (Δφ′) from the reference value Δu-ref (Δφ′ ref) occurs due to one of the above-mentioned reasons, then this is an index for changes in the paper properties and/or in the stretch ε in the paper and consequently also for relative changes in the circumference (ink) register, in the lateral register, and/or in the image length. A greater stretch, for example, permits the moment in the draw roller 11 to fall temporarily, whereupon this roller, since it is operated in a moment-controlled fashion, reacts by increasing the circumference speed u11. The actual value of the difference Δu then deviates from the previously stored reference value Δu-ref. This deviation and therefore also the deviation in the lateral register, the circumference register, and/or the image length is then compensated with the infeed unit 02 preceding the first printing unit 06 until the moment-controlled draw roller 11 once more reaches the circumference speed u11 required for the reference value Δu-ref. The circumference speeds u09 of the printing unit 09 and u11 of the draw roller 11 can be ascertained directly in one of the cylinders associated with the printing unit 09, for example directly in the transfer cylinder 18 or directly in the draw roller 11, or can be ascertained by means of an encoder disposed in a drive unit 14 or 19 or by means of a rotation sensor. The second circumference speed u11 or phase position φ 11 (φ′ 11) can also be ascertained another roller or another cylinder in the transport direction after the last printing unit 09, e.g. by means of a rotation sensor in an additional measuring roller.

The deviation from the reference value Δu-ref (Δφ′ ref) can be superimposed on a reference value generator of the drive control unit 16, for example in the form of a interference variable Δ. The drive control unit 16 of the draw roller 03 can, for example, be torque-controlled, which produces a restoring of the tension S2. A path of the web B over a corresponding measuring roller 21 for the measurement of the tension S2 of the web B is shown with dashed lines in FIG. 1. The reference value generator of the drive control unit 16 is superimposed by the interference variable Δ that corresponds to the deviation from the reference value Δu-ref, for example in the form of a correction variable AS2. A correction variable AS2 of this kind can, for example, be taken from a stored curve or can also be generated iteratively by increasing or decreasing the tension S2 until the difference Δu of the circumference speeds u09 and u11 once again corresponds to the reference value Δu-ref.

The circumference speeds u09 and u11 should be set equal to the speed u09; u11 of the web B (with curvature of the web B on the contact side) when the slippage is negligible. Consequently, in another embodiment of the invention, the speeds u09; u11 of the web B or their difference Δu can also be used the interference variable Δ for controlling the tension S2 if they are derived in another way. It is essential, however, that the speed u09 is the machine speed or the speed u09 of the web B in the vicinity of the printing units 06; 07; 08; 09 and that the speed u11 is the speed u11 of the web B after the last printing unit 09. Here, too, it is advantageous to embody the draw roller 11 so that it is moment-controlled during print running.

If abrupt changes in the influence of force on the web B are to be avoided, a drive control unit with DROOP behavior can also be used for the draw roller 03. DROOP behavior is a term used for a load-dependent change of the reference value of a circumference speed or rotation speed, which takes into account both a change in the tension of the web B, e.g. S4, and a change in the circumference speed, e.g. u11. In this case as well, the reference value S2-ref for the web tension S2 is superimposed by a correction variable AS2 as an offset, which, together with the actual value of the tension S2, in conjunction with the DROOP function, produces an appropriate lag of the draw roller 03.

Whatever the method used for controlling the draw roller 03 or the infeed unit 02, it is essential that the reference value for the drive control unit 16 be superimposed by an interference variable Δ ascertained from the difference Δu, for example as a correction variable AS2 of the desired tension S2. As needed, or under certain conditions, instead of being ascertained based on the last printing unit 09 in the transport direction T, which has the circumference speed u09, the machine speed can also be ascertained based on another printing unit 06 to 08. The difference Δu and the reference value Δu-ref must then be ascertained, for example, from u11 and u08, etc. and processed as interference variables Δ.

It is also essential that a change in this difference Δu permits the inference of a change dε in the stretch ε, the longitudinal stretch and/or lateral stretch ε of the web B after the last printing unit 09, and consequently a change in the lateral register and/or the image length of the web B, and that this results in a temporary speed change in the drive unit 14 of the draw roller 11. The relative speed change or deviation in the difference Δu from the reference value Δu-ref then in turn leads to the control of the infeed unit 02, which finally permits the moment-controlled draw roller 11 to return to its “normal operation”. A change in the stretch or the tension is measured after the last printing unit 09, but a control is executed at the infeed unit 02, which defines the overall tension level of the paper web B. Advantageously, there is no direct feedback to the draw roller 11 situated after the last printing unit 09; instead, a change in the overall tension level takes place at the infeed unit 02.

In lieu of the circumference speeds u09 and u11, as explained above, the angular positions of one of the printing units 06 to 09 and of the draw roller 11 can be used. When there is a change dε in the stretch ε, then there is consequently a deviation in the relative angular position. This difference value can then be used, in the form of an absolute value or as an absolute value with a sign, as an interference variable Δ for the control of the drive unit 13.

The method is suitable for printing presses with stacked printing units or printing unit disposed next to one another, which are combined to form bridge units or H-units, for rubber-against-rubber or rubber-against-steel printing units and other combinations.

Reference Numeral List

| | |
|---|---|
| 01 | roll changer |
| 02 | infeed unit |
| 03 | draw roller |
| 04 | — |
| 05 | — |
| 06 | printing unit |
| 07 | printing unit |
| 08 | printing unit |
| 09 | printing unit |
| 10 | — |
| 11 | draw roller |
| 12 | hopper infeed roller |
| 13 | drive unit |
| 14 | drive unit |
| 15 | — |
| 16 | drive control unit |
| 17 | drive control unit |
| 18 | transfer cylinder |
| 19 | drive unit |
| 20 | — |
| 21 | measuring roller |
| B | web; print stock web; paper web |
| T | transport direction |
| ε | stretch; lateral stretch |
| dε | change in stretch; change in lateral stretch |
| u09 | circumference speed, speed |
| u11 | circumference speed, speed |
| Δu | difference |
| Δu ref | reference value |
| φ 09 | rotation angle position, phase position (09) |
| φ 11 | rotation angle position, phase position (11) |
| φ′ 09 | change over time in the phase position (09) |
| φ′ 11 | change over time in the phase position (11) |
| Δφ′ | difference |
| Δφ′ | reference value |
| Δ | interference variable |
| S1 | tension |
| S2 | tension |
| S3 | tension |
| S4 | tension |
| ΔS2 | correction variable (S2 ref) |
| S2 ref | reference value (S2) |

1. A method for controlling a web tension in a rotary printing press, in which a web (B) passes through at least one printing unit (06; 07; 08; 09) and in which a tension (S2) of the web (B) is changed before the first printing unit (06), characterized in that the change in the tension (S2) of the web (B) takes place due to a change in a difference (Δu), which is ascertained from a first speed (u09) at a first location and a second speed (u11) at a second location.

2. The method according to claim 1, characterized in that
the first speed (u09) is ascertained as a circumference speed (u09) in a first printing unit (06; 07; 08; 09) and
the second speed (u11) is ascertained as a circumference speed (u11) in a draw roller (11) disposed after the last printing unit (09) in the transport direction (T),
the difference (Δu) between the two circumference speeds (u09; u11) is recorded as a reference value (Δu ref),
during print running, an actual value of the difference (Δu) is compared to the reference value (Δu ref),
and that a deviation in the difference (Δu) from the reference value (Δu ref) is used as an interference variable (Δ) for controlling an infeed unit (02).

3. The method according to claim 2, characterized in that during print running, the draw roller (11) is controlled as a function of a presettable moment.

4. The method according to claim 1, characterized in that the second speed (u11) is ascertained by means of a measuring roller after a last printing unit (09).

5. The method according to claim 2, characterized in that the second speed (u11) is ascertained by means of an encoder in the draw roller (11).

6. The method according to claims 1 or 2, characterized in that the first speed (u09) is ascertained at the last printing unit (09) in the transport direction (T).

7. The method according to claim 2, characterized in that the interference variable (Δ) is supplied to a drive control unit (16) of the draw roller (03) disposed before the first printing unit (06), preferably in the form of a correction variable (AS2) to a reference value (S2 ref) for a tension (S2) between the infeed unit (02) and the first printing unit (06).

8. The method according to claim 1, characterized in that the speeds (u09; u11) are ascertained based on rotation angle positions (φ 09, φ 11).

9. The method according to claim 2, characterized in that during the starting phase, without the addition of ink and water, the draw roller (11) is controlled as a function of a speed (u09; u11).
